(19) United States
(12) Patent Application Publication
(10) Pub. No.: US 2003/0106504 A1
(43) Pub. Date: Jun. 12, 2003

(54) Rotary engine

(76) Inventor: Dong-Hyun Kim, Daegu (KR)

Correspondence Address: BIRCH STEWART KOLASCH & BIRCH, PO BOX 747, FALLS CHURCH, VA, 22040-0747, US

(21) Appl. No.: 10/275,177

(22) PCT Filed: May 16, 2002
(86) PCT No.: PCT/KR02/00921

(30) Foreign Application Priority Data
May 26, 2001 (KR) 2001/5633 U
Jun. 21, 2001 (KR) 2001/35282
Feb. 26, 2002 (KR) 2002/10164

(51) Int. Cl. F02B 57/00

(52) U.S. Cl. 123/43 R; 123/241

(57) ABSTRACT

This invention is for a rotary engine which is composed of a housing(A) that has induction hole (10), exhaust hole (12), and ignition plug (14), and a rotation body (C) which is installed to possibly rotate around the axis of rotation (2) in the housing (A), and an oval gide part (D) which is located in the center of the rotation body (C) prominent from the housing (A), and a piston (B) which is installed to possibly rotate around the shaft stick (4) of the operation room (44) formed in the rotation body (C), and its tail (58) and front (59) circumscribes with the guide part (D), and a guide bar (8) which is connected and formed at edge of the shaft stick (4) of the piston (B) and the guide roller (62) at the edge inscribes with

### TECHNICAL FIELD

This invention is about the Rotary Engine among the internal combustion engines.

### BACKGROUND ART

The ordinary rotary engines are designed to work the four step strokes by the triangular rotor rotating eccentrically in the housing. To make such housing and rotor is hard due to their geometrical structure, and the rotary friction of the rotor is heavy when working. Accordingly, the abrasion ratio of the rotor is high, and it is pointed out that there are many problems such as producing much smoke when burning because lubricating oil is mixed into the fuel as there is no independent lubricating function. Therefore, it has not been actualized yet even though it has many merits because it is small and light comparing with the other reciprocating engines of same power.

### DISCLOSURE OF THE INVENTION

To solve the above problems in this invention, it is designed that the 4 strokes of engine is performed by the piston operation compressing and expanding the operation room by its sliding moving while the piston of the rotation body, which is rotating the axis of rotation in the cylinder type housing circumscribes with the oval guide part. This oval guide part is prominently formed from the housing toward the central part of the rotation body.

Also, in this piston of the rotation body, the shaft stick is connected to the guide bar which has a guide roller, and the guide roller is internally contacted with the oval guide surface of the housing. By this structure, every compression and/or expansion of the operation room in each strokes can be smoothly accomplished even at the operation of centrifugal force.

During the process of the 4 strokes, the lubricating oil is flowed in through the lubricating oil supply route and supply hole which are formed in axis of rotation, and is flowed out through the discharge route and discharge hole to be circulated. And then, those the induction hole which intakes the fuel, the exhaust hole which discharges the exhausting gas, and the operation room are shut tight by oil seal so that the flow in of the lubricating oil into the operation room may be cut off while lubricating.

Consequently, in this invention, the composition is comparatively simple, and manufacturing is easy. The operation of rotation body and piston is supple to be smoothly accomplished. Thus, vibration noise and abrasion ratio of piston can be) reduced and the smoke decrease due to its independent lubricating function.

### BRIEF DESCRIPTION OF THE DRAWINGS

FIG. 1 is side cut view of this invention;

FIG. 2 is deal drawings of this invention;

FIG. 3 is partial view of the exhaust hole in this invention;

FIG. 4 is structural drawing of oil groove for discharge of lubricating oil in the bottom of rotation body in this invention;

FIG. 5 is view of the piston used in this invention;

FIG. 6 is plane view of this invention;

FIG. 7 is plane view which shows the working motion of guide bar in this invention;

### BEST MODE FOR CARRYING OUT THE INVENTION

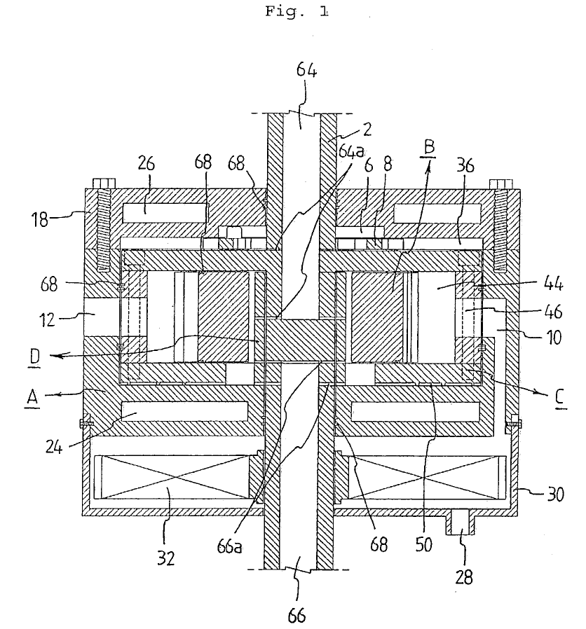

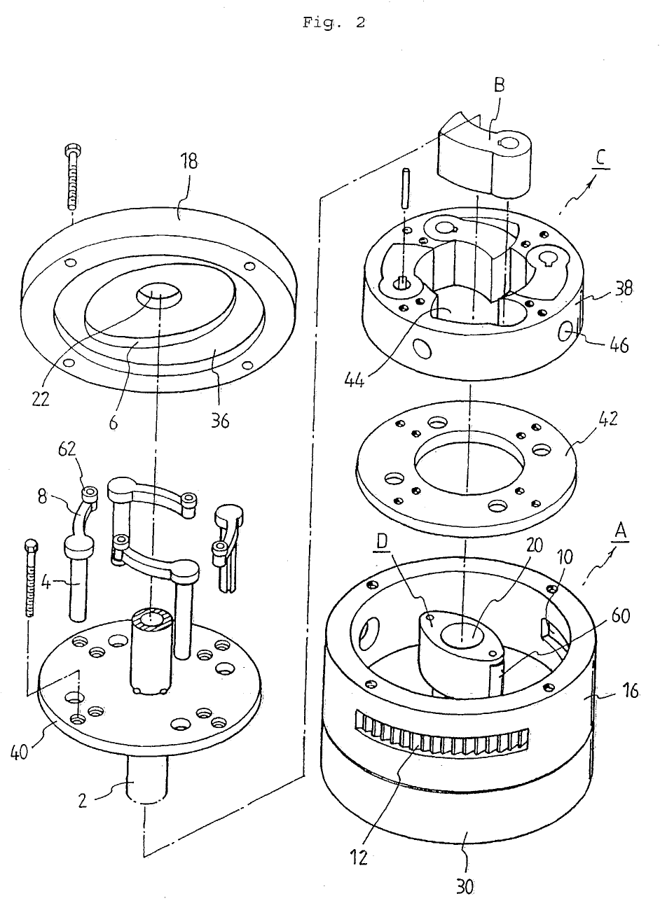

This invention is, as shown in the FIGS. 1 and 2, is composed of a cylinder type housing(A), a rotation body(C), an oval guide part(D), and a guide bar. In this composition, the rotation body(C), in which more than one(1) piston(B) is installed, is rotating around the axis of ration(2) in the housing(A). And the oval guide bar(D) is prominently formed at the internal surface of the housing(A) toward the central part of the rotation body(C). Also, the guide bar(8) is formed at the shaft stick(4) which is connected with the piston(B) and guided by the guide surface(6) of the housing(A).

The induction hole(10) for fuel induction and exhaust hole(12) for gas exhausting are formed at the both sides of the housing(A), and between them, ignition plug(14) or fuel supply device is alternatively installed by the desirable engine(gasoline engine or diesel engine). The body(16) in which an oval guide part(D) is prominently formed at the internal wall of the housing(A) and a lid(18) which is jointed by volts with the body(16) are composed in the internal space of the housing(A), and a shaft hole(20) (22) through which a axis of rotation(2) penetrates is formed at the guide part(D) and lid(18) of the body(16).

The body(16) and lid(18), which composes of housing(A), forms cooling rooms(24)(26) which are filled with cooling liquid. At the bottom of the body(16), the cover(30) which has the fuel inflow pipe(28) is jointed by volts. And in the cover(30), the fuel pressure apparatus(32) is set, and the fuel pressure apparatus(32) in turbine pattern is fixed on the axis of rotation(2).

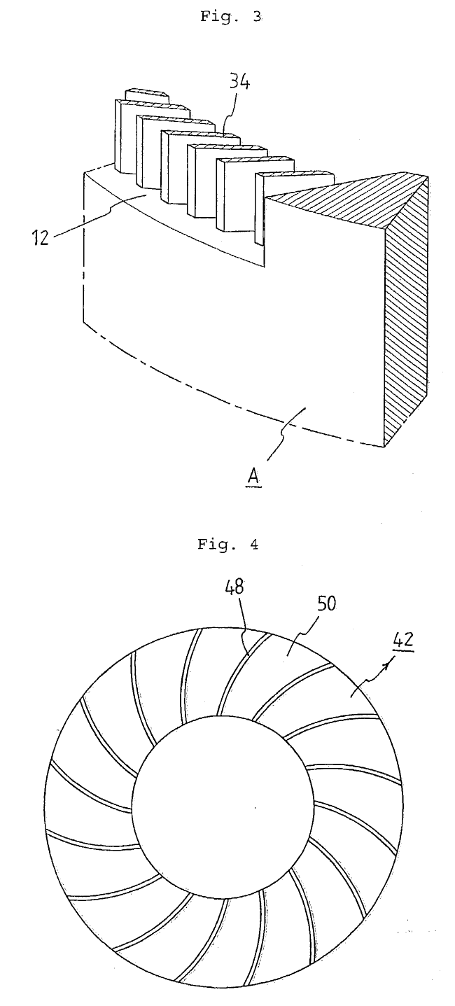

In the exhaust hole(12), which is formed at the body(16) of the housing(A), several slant boards(34) are set close together toward the turning direction of the rotation body(C) to increase the driving force when exhausting, as shown in FIG. 3.

The oval guide part(D), prominently formed at the internal wall of the body(16), has the shortest bottom point of stroke and the longest peak point of stroke from the central point of the shaft hole(22), and is located in the center of the rotation body(C).

The operation space(36) and oval guide surface(6) are formed at the internal side of the lid(18), and the operation space helps the operation of the guide bar(8) free, and the oval guide surface is engraved at the operation room. The oval guide surface(6) keeps elliptical orbit in which the piston(B) can keep the circumscribed position with the guide part(D) through the inscribed guide bar(8).

The rotation body(C) is composed of the cylinder shaped body(38) and the airtight board(40)(42) which are jointed by volts at the both sides of the body(38), and the axis of rotation(2) is formed in one body with one of the airtight boards(40).

More than one operation rooms(44) are formed in the body(38) of the rotation body(C), and in each operation room, air hole(46) is formed, which inhales the fuel and exhausts gas after combustion. The air hole(46) carries out the function of the operation room(44) as a part of the operation room(44) as well as inhales fuel and exhausts gas.

At the outer surface of the other airtight board(42) of the rotation body(C) as shown in FIG. 4, many of the guide prominences(48) are radiately formed, and there, the oil route(50), which promotes exhausting of lubricating oil, is formed.

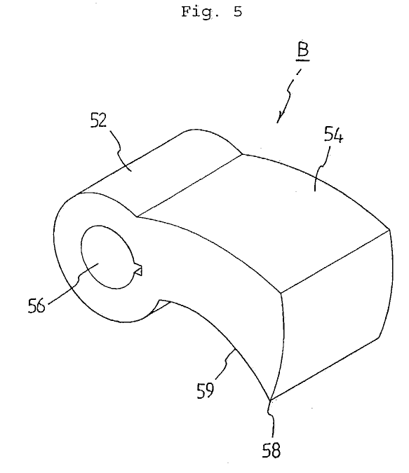

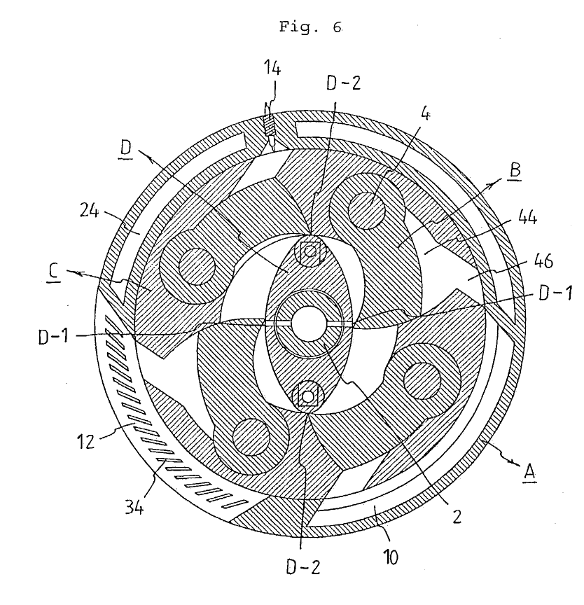

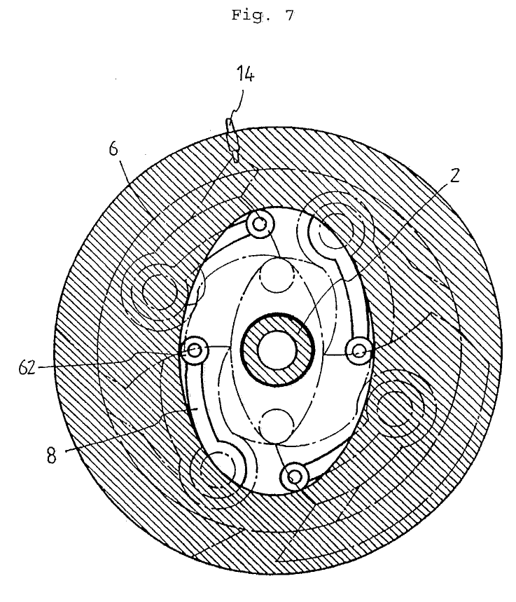

The piston(B) is installed in the each operation room(44) of the rotation body(C) as shown in FIG. 5, and is composed of the round head(52) and the body(54) which is formed in curve from one side of the head(52) toward inner side. This piston(B) is connected to the rotation body(C) with the shaft stick(4) through the connecting hole(56) of the head(52), and the tail(58) of the edge of body(38) and the front(59) are circumscribed to the oval guide part(D).

It is desirable to install the guide roller(60) at the tail(58) of the above piston(B) and the peak point of stroke(D-2) to decrease friction when rotating.

The shaft hole(4) which connects the piston(B) is formed in monolithic organization with the piston(B) through the connecting hole(56) from outside of airtight board(40) in one side of the rotation body(C), and the guide bar(8) is also formed in monolithic structure with the edge of the shaft hole(4) which is exposed out. The edge of the guide bar(8) forms guide roller(60) (62) and is touched internally with the guide surface(6) of the housing(A) through the guide roller(62).

The axis of rotation(2) is formed in monolithic structure at the other side of the airtight board(40) of the rotation body(C), and provides with lubricating oil supply route(64) and lubricating, oil discharge route(66) at inside. The lubricating oil supply route(64) is connected with the inner part of the engine by the supply holes(64a) and the lubricating oil discharge route(66) is connected with the inner part of the engine by the discharge holes(66a).

Oil seal(68) is formed between the housing(A) and the rotation body(C), and between the rotation body(C) and piston(B), respectively. And this oil seal(68) prevents lubricating oil from flowing into the operating room(44), air hole(46), induction hole(10), and exhaust hole(12).

The ignition plug(14) of this invention is located at the point of being ignited when the piston(B) passes by the peak point of stroke(D-2) of the guide part(D). If a fuel supply device is installed at the ignition point instead of the ignition plug(14), it is satisfactory for diesel engine.

As being composed as above in this invention, the piston(B) contracts and expands the volume of operation room(44) when passing by the bottom point of stroke(D-1) and the peak point of stroke(D-2) of the oval guide part(D) because the tail(58) circumscribes with the guide part(D) and the guide roller(62) of the guide bar(8), which is set up at the shaft stick(4), inscribes with the guide surface(6) of the housing(A) when the rotation body(C) rotates.

At this time, the tail(58) of the piston(B) begins to rotate toward the center of the rotation body(C) around the shaft stick(4) by moving to the bottom point of stroke(D-1) passing by the peak point of stroke(D-2) of the guide part(D) from the time that the air hole(46) of the operation room(44) meets the induction hole(10). According to the above rotation, the operation room(44) is contracted to the minimum size and then expanded more and more. And the fuel, which flowed into the fuel inflow pipe(28) by injection at the maximum expansion of the operation room(44), is strongly induced into the operation room(44) throughout the induction hole(10) as being pressurized by the fuel pressure apparatus(32).

This kind of induction operation continues while the air hole(46) of the operation room(44) passes by the induction hole(10) of the housing(A). In this stroke, even though the centrifugal force occurs to the piston(B) by the rotation of rotation body(C), the strokes are normally performed because the guide bar(8), which is connected to the shaft stick(4), inscribes with the oval guide surface(6) of the housing(A) through the guide roller(62).

That is, the piston(B) circumscribes with the guide part(D), and by sliding moving, it contracts and/or expands the operation room(44). But, the tail (58) can not keep the sliding touch with the guide part(D) especially in the inhaling course of no affection of out force because there is regular centrifugal force by rotation of the rotation body(C).

But, as shown in the FIG. 7, the tail(58) of the piston(B) always circumscribes with the guide part(D) without any affection of the centrifugal force and works round moving because the tail(58) of the piston(B) always circumscribes with the guide part(D) and the guide bar(8) inscribes with the guide surface(6) of the housing(A) through the guide roller(62).

After the air hole(46) of the rotation body(C) passes by the induction hole(10) of the housing(A), the operation room(44) and air hole(46) are hermetically closed by oil seals(68) which are surrounding the inner surface of the housing (A), the operation room(44), and the air hole (46).

Thus, an induction stroke is completed.

When a induction stroke is completed, the tail(58) of the piston(B) moves to the peak point of stroke(D-2) passing by the bottom point of stroke(D-1) of the guide part(D), and so, the minimized operation room(44) at the bottom point of stroke is step by step contracted to compress the fuel.

If the tail(58) of the piston(B) reaches to the peak point of stroke, the volume of the operation room(44) is minimized and the fuel is maximum compressed, and the compression stroke is completed.

When the ignition plug(14) is fired at the maximum compression, the fuel is burned to begin the expansion stroke. As the expansion force pulls the back of the piston(B), the rotation body(C) gets the rotation power to rotate in the opposite direction of clock hand.

At this time, the tail(58) of the piston(B) moves to the bottom point of stroke(D-1) passing by the peak point of stroke(D-2), and the operation room(44) is gradually expanded. By continuation of rotation, when the air hole(46) of the operation room(44) meets the exhaust hole(12), the expansion stroke is completed and exhaust stroke is begun.

When the exhaust stroke begins, again the tail(58) of the piston(B) moves to the peak point of stroke(D-2) passing by the bottom point of stroke(D-1), and accordingly the minimized operation room(44) is gradually contracted and the exhaust is rapidly proceeded.

At the exhaust stroke, many slant boards are formed in the exhaust hole(12) as shown in FIG. 3, the driving force is added by operation of the slant boards(34).

When the air hole(46) of the operation room(44) completely passes by the exhaust hole(12), the exhaust stroke is completed. At this time, the tail(58) of the piston(B) again moves to the bottom point of stroke(D-1) passing by the peak point of stroke(D-2), and the minimized operation room(44) is gradually expanded passing by the induction hole(10), and again the induction stroke which sucks in the fuel begins to repeat its stroke.

During these 4 step strokes, the lubricating oil, which supplied through the lubricating oil supply route(64) of the axis of rotation(2), is induced into between the housing(A) and rotation body(C), between the rotation body(C) and piston(B), and between the axis of rotation(2) and housing(A) and/or the guide part(D) evenly among all through the supply holes(64a) to enable the rotation smooth. Thus, the circulating operation of the lubricating oil, of which the lubricating oil is exhausted through the supply hole(66a) lubricating oil discharge route(66), is performed.

There is no worry about generation of smoke caused by the combustion of the lubricating oil because the induction hole(10), exhaust hole(12), operation room(44), and air hole(46) are hermetically closed by oil seal(68) to prevent the inflow of lubricating oil into them.

When the lubricating oil is exhausted, the lubricating oil is rapidly moving to the central part through the oil route (50) in the gabs of the radial guide prominences(48) by rotation of the rotation body(C), and the lubricating operation is smoothly performed.

Industrial Applicability

In this invention, 4 strokes are performed by the piston(B) of the rotation body(C) by circumscribing with the guide part(D) and by sliding moving in the housing(A). Therefore, this invention is very effective in easy manufacturing due to comparatively simple composition, smooth and tender operation with less rotation friction, less noise, low abrasion ratio of the piston(B), and no worry about smoke generation from lubricating oil due to the independent lubricating function, comparing with the ordinary rotary engines in which the 4 strokes are performed by the triangle rotor is eccentrically rotating.

1. A rotary engine which is composed of a cylinder shaped housing(A), rotation body(C) rotating in the housing(A), an oval guide part(D) located at the center of the rotation body(C) which is prominently formed from the housing(A), and a axis of rotation(2) which is formed in monolithic structure with the rotation body(C) penetrated through the housing(A) and guide part(D), and forms the induction hole(10) and exhaust hole(12), or ignition plug(14) or other fuel supply device in selection up to the engines, and forms more than one operation room(44) being furnished with air hole(46) and located in the rotation body(C), and sets piston(B) at one side of the above operation room(44) to be rotated, and let the tail(58) and front(59) circumscribe with the guide part(D), and sets the guide bar(8) which inscribes with the guide surface(6) of the housing(A) through the guide roller(62) at the shaft stick(4) connecting the piston(B).

2. A rotary engine that forms the lubricating oil supply route(64) at the axis of rotation(2) of the rotation body(C), supply hole(64a), lubricating oil discharge route(66), discharge hole(66a), and in which all around the operation room(44) and the air hole(46) are hermetically closed by the oil seal(68), in the above claim 1.

3. A rotary engine that fixes and joins the cover(30) which is formed with fuel inflow pipe(28) at one side of the housing(A) and installs a fuel pressure apparatus(32) which is connected at and fixed to the axis of rotation(2) in the cover(30), in the above claim 1.

4. A rotary engine that is composed to form many guide prominences(48) in all direction at one side of the rotation body(C), and forms the oil route(50) around them, in the above claim 1.
